(19) United States
(12) Patent Application Publication
(10) Pub. No.: US 2008/0201498 A1
(43) Pub. Date: Aug. 21, 2008

(54) DATA COMMUNICATION SYSTEM, DATA COMMUNICATION PROGRAM RECORDING MEDIUM, DATA COMMUNICATION METHOD, DATA RECEIVING DEVICE, AND DATA RECEIVING PROGRAM RECORDING MEDIUM

(75) Inventor: Hiroshi Ohkubo, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/930,824

(22) Filed: Oct. 31, 2007

(30) Foreign Application Priority Data
Feb. 15, 2007 (JP) 200735349

(51) Int. Cl. G06F 13/18

(52) U.S. Cl. 710/33

(57) ABSTRACT

A data communication system includes a receiving unit that receives communication data, one data element at a time; a first storage unit that temporarily stores the received data element; a first transfer unit that transfers the stored data element; a second storage unit that temporarily stores the transferred data element; a second transfer unit that transfers the secondly stored data element; a third storage unit that stores the secondly transferred data elements; a change unit that changes data element storage capability of the second storage unit; and a diagnostic unit that diagnoses communication efficiency of the data, wherein the receiving unit controls reception of a next data element based on the data element storage-ability status of the first storage unit, and the first transfer unit controls transfer of data elements based on the data element storage-ability status.

### CROSS-REFERENCE TO RELATED APPLICATIONS

This application is based on and claims priority under 35 USC 119 from Japanese Patent Application No. 2007-035349, filed on Feb. 15, 2007.

### BACKGROUND

1. Technical Field

The present invention relates to a data communication system, a data communication program recording medium, a data communication method, a data receiving device, and a data receiving program recording medium.

2. Related Art

In general, communication between devices is carried out on the basis of some standard. For example, IEEE (Institute of Electrical and Electronic Engineers) 1394 and USB (Universal Serial Bus) are used widely in serial communication. IEEE1394 is a standard defining the transfer speeds of 100 Mbps, 200 Mbps, and 400 Mbps. USB is a standard defining the FS (full speed) mode with the maximum transfer speed of 12 Mbps used by USB1.1 and the HS (high speed) mode with the maximum transfer speed of 480 Mbps added by USB2.0.

### SUMMARY

According to an aspect of the invention, there is provided a data communication system including a receiving unit that receives communication data, one data element at a time; a first storage unit that temporarily stores the received data element; a first transfer unit that transfers the data element stored in the first storage unit; a second storage unit that temporarily stores the data element transferred by the first transfer unit; a second transfer unit that transfers the data element stored in the second storage unit; a third storage unit that acquires the data elements transferred by the second transfer unit and stores the data; a change unit that changes data element storage capability of the second storage unit; and a diagnostic unit that diagnoses communication efficiency of the data on the basis of the storage capability changed by the change unit, wherein the receiving unit controls reception of a next data element on the basis of a data element storage-ability status of the first storage unit, and the first transfer unit controls transfer of data elements from the first storage unit to the second storage unit on the basis of a data element storage-ability status of the second storage unit.

### BRIEF DESCRIPTION OF THE DRAWINGS

Exemplary embodiment(s) of the present invention will be described by reference to the following figures, wherein:

FIG. 1 is a diagram showing an example of the hardware configuration of a USB communication system;

FIG. 2 is a diagram showing the software and hardware hierarchy of the USB communication system;

FIG. 3 is a diagram showing packets that are sent and received during bulk-out transfer;

FIG. 4 is a diagram showing packets that are sent and received during the bulk-out transfer;

FIG. 5 is a diagram showing packets that are sent and received during the bulk-out transfer;

FIG. 6 is a diagram showing data transfer in a target device;

FIG. 7 is a diagram showing the flow of processing for the buffers in a kernel area;

FIG. 8 is a diagram showing the structure of an IO request structure;

FIG. 9 is a diagram showing IO requests and an IO request wait queue;

FIG. 10 is a diagram showing an IO request and an IO request completion queue;

FIG. 11 is a flowchart showing buffer setting processing for the kernel area;

FIG. 12 is a flowchart showing processing for finding the optimum buffer setting;

FIG. 13 is a diagram showing the measurement range of processing speeds;

FIG. 14 is a schematic diagram showing the relation between number of buffers and processing time; and

FIG. 15 is a table showing the optimum values of buffers for a combination of target devices and host machine types.

### DETAILED DESCRIPTION

Exemplary embodiments will be described below.

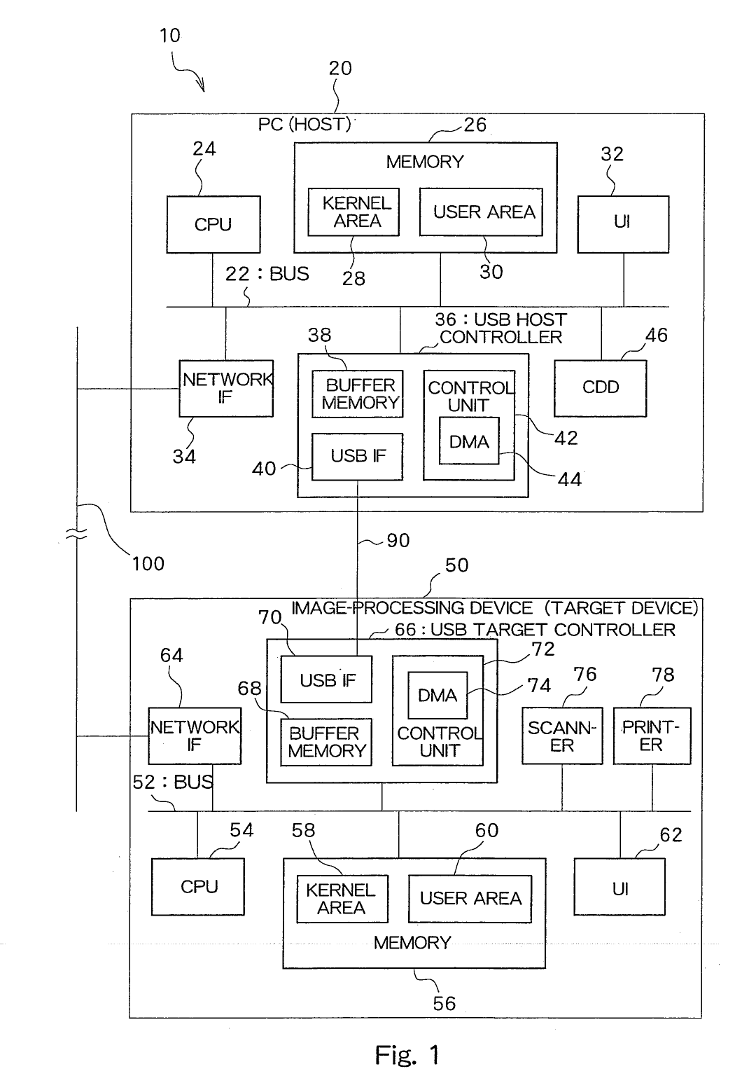

FIG. 1 is a diagram showing the overview of the hardware configuration of a USB communication system 10 of an exemplary embodiment. This USB communication system 10 is an example of a data communication system based on the USB standard. The USB communication system 10 includes a PC (Personal Computer) 20 that functions as a USB host; an image-processing device 50 that is a target device; and a USB cable 90 that connects these devices. The PC 20 and the image-processing device 50 are connected also to a network 100 such as the Internet.

In the description below, the PC 20, a general-purpose computer, is assumed to be a notebook computer that the owner can transport. The PC 20 has a bus 22 that is an internal communication path to which various devices are connected, including a CPU (Central Processing Unit) 24, a memory 26, a UI (User Interface) 32, a network IF (Interface) 34, a USB host controller 36, and a CDD (Compact Disc Drive) 46.

The CPU 24 is a device that executes calculation and control operations in accordance with programs (software) stored in the memory 26. The CPU 24 also controls the operation of the devices via the bus 22, and controls communication between devices and with external devices. The memory 26 is a storage device having storage areas made up of semiconductors or a magnetic disk. The memory 26 stores an OS (Operating System), device drivers, application programs, and various types of data (in the description below, program code that is communicated is sometimes called data). In general, the OS controls the allocation of the storage areas of the memory 26. The OS controls the memory in this way to build a kernel area 28 used by the OS or the device drivers, and a user area 30 used by application programs.

The UI 32 includes input devices such as a keyboard and a track point, and a display device such as a liquid crystal display. The UI 32 accepts a user's instruction from an input device and displays data, which will be presented to the user, on the display. The network IF 34 is an interface for connection to the network 100. The network IF allows the PC 20 to send and receive programs and data to and from an external device. For example, a program for controlling the PC 20 (the control program of the CPU 24, the control program of the USB host controller 36, etc.) is acquired from the network 100.

The USB host controller 36 is a communication control device that controls USB communication and, via the USB cable 90, sends and receives data to and from a target device. The USB host controller 36 includes a buffer memory 38, a USB IF (USB interface) 40, and a control unit 42. The buffer memory 38, which is a first-in/first-out storage device configured by semiconductor memories, temporarily stores input or output data. The USB IF 40 is an interface for connecting the USB cable 90. The control unit 42 has an operation processing function and controls the USB host controller 36. The control unit 42 controls the buffer memory 38 and the USB IF 40 under instructions from the CPU 24. The control unit 42 has a DMA (Direct Memory Access) 44. The DMA 44, a device for controlling data communication between the buffer memory 38 and the memory 26, directly controls communication between the buffer memory 38 and the memory 26 rather than via the CPU 24.

The CDD 46 is a device that writes or reads data to or from a CD (Compact Disc), which is a storage medium. For example, the programs that control the PC 20 (control program of the CPU 24, the control program of the USB host controller 36, etc.) are recorded on a CD for distribution. In this case, the programs can be acquired from the CD via the CDD 46.

The image-processing device 50 is a computer system that has an enhanced image processing function. The image-processing device 50 includes a bus 52 used as an internal bus, and devices connected to the bus 52 such as a CPU 54, a memory 56, a UI 62, a network IF 64, a USB target controller 66, a scanner 76, and a printer 78. The bus 52, CPU 54, memory 56, and network IF 64 have configurations similar to those of the corresponding units in the PC 20, and the memory 56 is also similar to the memory in the PC 20, in that it has a kernel area 58 and a user area 60. The UI 62 is similar to that in the PC 20, in that it has input devices and a display device, but differs from that of the PC 20 in that the input device is configured primarily by buttons and a touch panel. The USB target controller 66 has almost the same configuration as that of the USB host controller 36, except that the USB target controller 66 is used as a target device in USB communication. That is, a USB IF 70 and a control unit 72 are provided in the USB target controller 66 as the receiving units. The scanner 76 is a reading device that reads data from paper and generates image data, and the printer 78 is a printing device that prints on paper on the basis of image data. The image-processing device 50 can copy data by cooperative operation of the built-in scanner 76 and the printer 78.

The user can connect the PC 20; for example, a notebook PC, to the image-processing device 50 via the USB cable 90 to maintain the image-processing device 50 or to print data by means of the printer 78 of the image-processing device 50. In the USB communication, the two devices that are connected to each other are not peer-to-peer, but one is a host and the other is a target device. In the example shown in FIG. 1, the PC 20 is a host and the image-processing device 50 is a target. As in the configuration described above, in many cases a software-reconfigurable device is selected as the host, and a fixed-function device is selected as the target. Note that, however, it is also possible to set the image-processing device 50 as the host, and the PC 20 as the target.

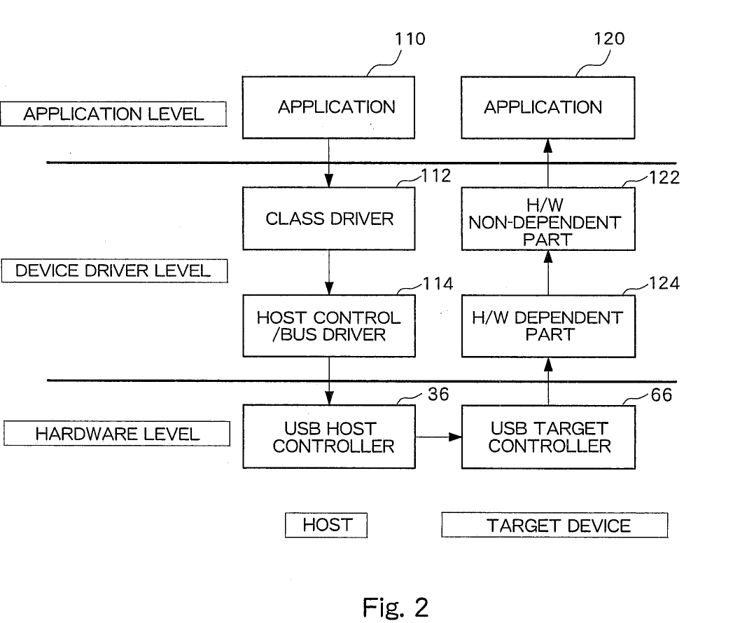

Next, the following describes USB communication with reference to FIG. 2. FIG. 2 is a diagram showing the software and hardware hierarchy of the host (PC 20) and the target device (image-processing device 50) in the USB communication. Referring to the figure, the configuration of the host and the target device is divided into three hierarchical levels: application level, device driver level, and hardware level. In the host, the application level is configured by the programs of an application 110, and the device driver level is configured by a class driver 112, which is a general-purpose high-level driver; a bus driver; which implements the USB-specific protocol; and a host control driver, which abstracts the USB host controller 36 (the latter two are called host control/bus driver 114). The hardware level of the host is configured by the USB host controller 36 shown in FIG. 1. Meanwhile, in the target device, the application level is configured by the programs of an application 120, and the device driver level is configured by software having an H/W (hardware) non-dependent part 122 and an H/W dependent part 124. The hardware level of the target device is configured by the USB target controller 66 shown in FIG. 1. As described above, the device driver level is divided into the H/W (hardware) non-dependent part 122 and the H/W dependent part 124. This divided configuration eliminates or reduces an effect on the H/W dependent part when the USB target controller 66 is replaced by another unit. It is also possible to combine these parts into one.

USB defines not only the controlled transfer that is the default type, but also the bulk transfer for transferring a large amount of data, the interrupt transfer for transferring a small amount of data periodically, and the isochronous transfer that guarantees the amount of data transferred during a fixed time. The following describes an example of the bulk-out transfer, which is the bulk transfer from the host to the target in the HS mode. This transfer is used, for example, when image data to be printed are transferred from the PC 20 to the image-processing device 50 or when a program for control operations is transferred.

When the application 110 of the host sends data, which are to be communicated, to the application 120 of the target controller in the bulk-out mode, data are first transferred from the application 110 to the class driver (for example, printer class) 112. Next, the class driver 112 transfers the data to the host control/bus driver 114. After that, the host control/bus driver 114 divides the data into 512-byte packets (this packet is a data element transferred in a single operation) based on the USB2.0 standard and sends the packets as the OUT transaction using the USB host controller 36.

Each data packet that is sent arrives at the USB target controller 66 of the target device via the USB cable 90. The USB target controller 66 receives the data packet and stores it temporarily in a buffer memory 68. More specifically, the buffer memory 68 is configured by FIFOs (first-in first-out storage units) each of which can store one data packet (maximum of 512 bytes according to USB 2.0 specification), and the data packet is stored in this FIFO. Multiple logical communication paths (pipes) can be set between one target device and the host. The end of the target device side of each pipe is called an endpoint and, usually, a FIFO that can physically store one data packet is provided. The number of FIFOs may be fixed or variable. In general, the greater the number of FIFOs, the faster the data can be transferred. Multiple endpoints mean that an endpoint for bulk-out 1 and an endpoint for bulk-out 2 can be prepared and, in this case, bulk-out 1 and bulk-out 2 are completely independent of each other to thereby allow execution of different applications. In the description below, it is assumed that the buffer memory 68 has two FIFOs.

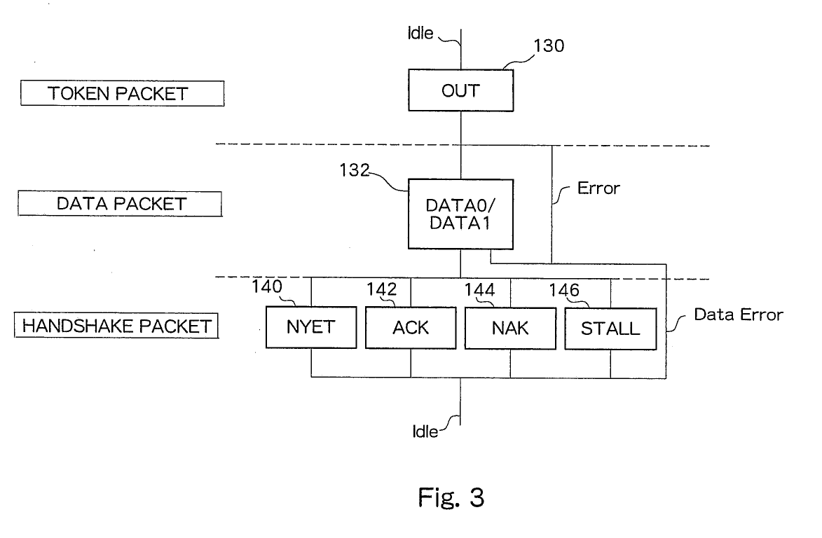

FIG. 3 shows the types of packets transferred between the USB host controller 36 and the USB target controller 66 during a bulk-out transfer transaction. First, the USB host controller 36 sends an OUT token packet 130 to notify the USB target controller 66 that the bulk-out transfer is started. Upon receiving this packet, the USB target controller 66 identifies that the transfer that will be performed is a bulk-out transfer and prepares FIFOs in which a data packet is to be stored at the endpoint for the bulk-out. Next, the USB host controller 36 sends data by means of a data packet 132 named DATA0. The USB target controller 66 receives the data packet DATA0 and stores it in one of the FIFOs prepared at the endpoint of the pipe. At this time, another FIFO of the two FIFOs is available for use. Therefore, the USB target controller 66 sends an ACK handshake 142 to the USB host controller 36 to indicate that the next data packet 132 can be received. In response to the ACK handshake 142, the USB host controller 36 sends the OUT token packet 130 and the data packet 132 named DATA1. The USB target controller 66 receives this data packet 132 and stores it in the other FIFO.

Now, consider a case when the FIFO in which the DATA0 data packet 132 was stored first is free; that is, when the data have already been transferred from the FIFO to the device in the subsequent stage and the FIFO is ready to receive a new data packet. In this case, the USB target controller 66 sends the ACK handshake 142 to indicate that it can receive the next data packet 132. On the other hand, when the FIFO in which the DATA0 data packet 132 was stored first is still in use; that is, when the data have not yet been transferred from the FIFO to the device in the subsequent stage, different processing is performed. That is, in this case, the USB target controller 66 sends an NYET handshake 140 to the USB host controller 36 to indicate that it cannot receive the next data packet.

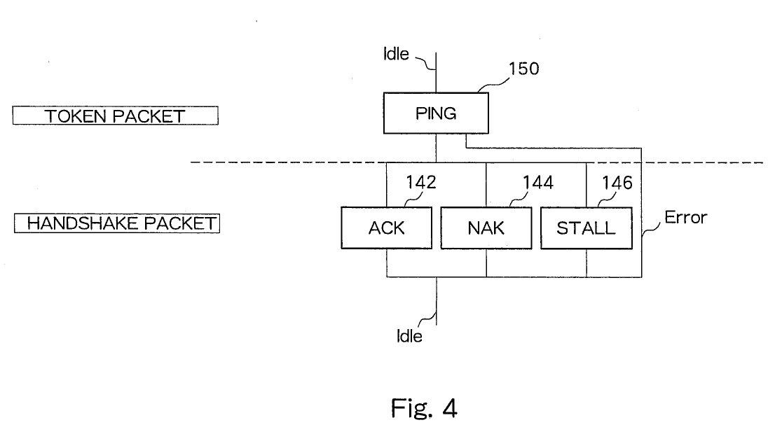

FIG. 4 is a diagram showing how packets are transferred when the USB host controller 36 receives the NYET handshake 140. In this case, the USB host controller 36 issues a PING token packet 150 instead of the OUT token packet 130. When the FIFO storing the DATA0 data packet 132 is not available for use, the USB target controller 66 sends a NAK handshake 144 to the USB host controller 36; when the FIFO is available for use, the USB target controller 66 sends the ACK handshake 142 to the USB host controller 36. When the ACK handshake 142 is received, the USB host controller 36 issues the OUT token packet 130, shown in FIG. 3, to restart the OUT transaction. On the other hand, when the NAK handshake 144 is received, the USB host controller 36 issues the PING token packet 150 again. This PING token packet 150 is issued repeatedly until the ACK handshake 142 is received from the USB target controller 66. When a stall condition occurs, the USB target controller 66 returns a STALL handshake 146. The handshakes described above are packets for carrying out connection-oriented (interactive) communication between the target device and the host.

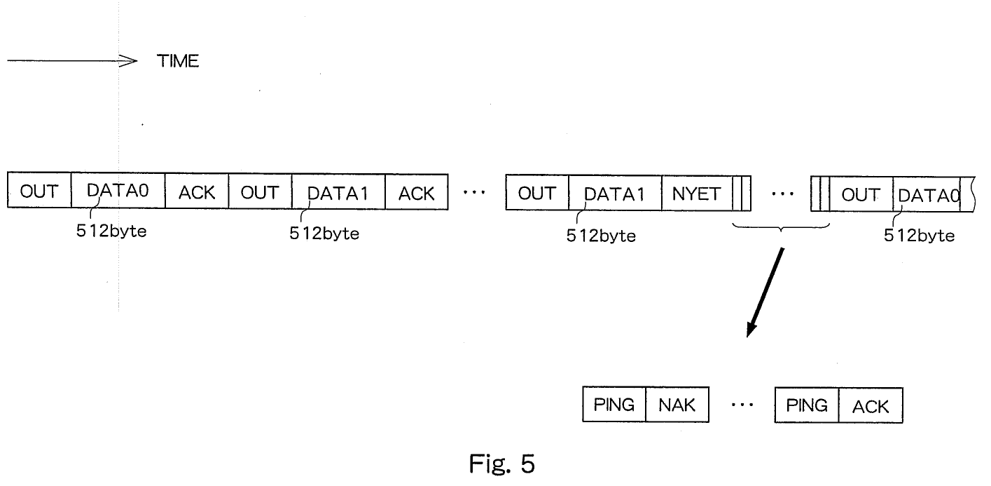

FIG. 5 is a diagram showing the packet flow in a sequence of data transmission. In the figure, the packets flowing through the USB cable 90 are shown from left to right on a time-series basis. In this example, the packets are communicated in sequence of the OUT token packet, the DATA0 data packet, the ACK handshake, the OUT token packet, the DATA1 data packet, and ACK handshake. In this way, the 512-byte DATA0 and 512-byte DATA1 are sent repeatedly. When there is no free FIFO at some point (no more packets can be stored), the NYET handshake is sent to the USB host controller 36. Upon receiving the NYET handshake, the USB host controller 36 issues a PING token packet and the USB target controller 66 returns the NAK handshake, and this communication is repeated at short intervals. When a free FIFO becomes available for use, the USB target controller 66 sends the ACK handshake. In response to this handshake, the USB host controller 36 restarts the transmission of the OUT token packet and the DATA0 data packet.

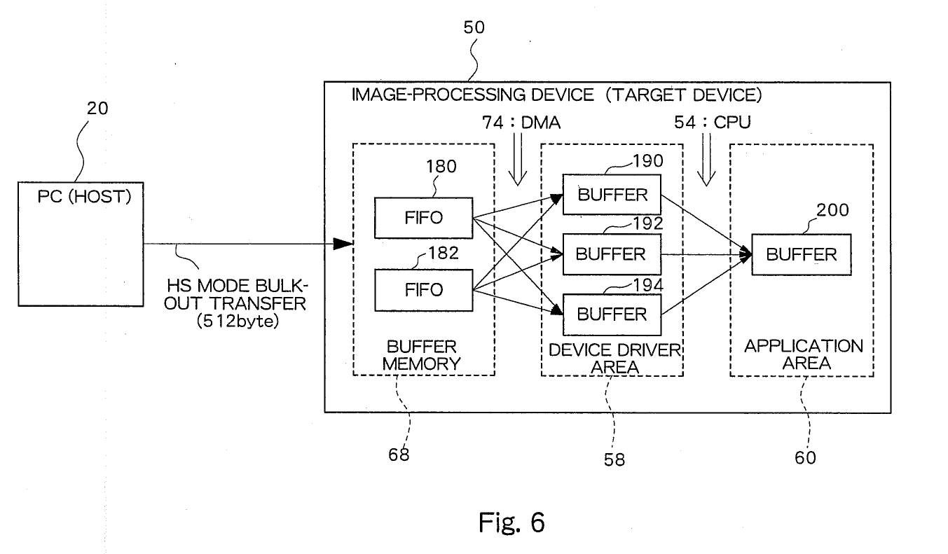

Next, with reference to FIG. 6, the following describes the flow of a data packet received by the USB target controller 66. FIG. 6 is a diagram showing how a data packet is transferred in the image-processing device 50 (target device) when the PC 20 (host) shown in FIG. 1 performs the bulk-out transfer (the data packet is 512 bytes in size) in the HS mode. The transfer of a data packet, as mentioned here, refers to the transmission of a data packet from one stage to the next stage. That is, the transfer of a data packet may be the writing (copying) of the data packet in the next stage while the data packet is still in the previous stage, or may be the passing of the data packet to the next stage while the data packet in the previous stage is erased.

Each data packet received by the USB IF 70 of the USB target controller 66 is stored temporarily in one of FIFOs 180 and 182 that are set at the endpoint. The FIFOs 180 and 182, which are the areas allocated in the buffer memory 68 of the USB target controller 66, act as a first storage unit.

The data packet stored in one of the FIFOs 180 and 182 is transferred to the kernel area 58 in the memory 56 by the DMA 74 in the USB target controller 66. The kernel area 58 has buffers 190, 192, and 194 for temporarily storing the data packets transferred from the FIFOs 180 and 182. Each of the buffers 190, 192, and 194 is large enough to store at least one data packet. When one of the buffers 190, 192, and 194 is free, the DMA 74 transfers the data packet stored in one of the FIFOs 180 and 182. The buffers 190, 192, and 194 act as a second storage unit. The DMA 74 functions as a first transfer unit that transfers the data packet from the first storage unit to the second storage unit.

The data packet stored in the kernel area 58 is transferred to a buffer 200 allocated in the user area 60. The buffer 200 is large enough to store the whole data, and the data packets are integrated into one in this buffer. The data restored in this way are managed and used by the application. The CPU 54 transfers the data packet from the kernel area 58 to the user area 60. The CPU 54 functions as a second transfer unit that transfers the data packet from the second storage unit. The application functions as a third storage unit that stores the data transferred from the second transfer unit.

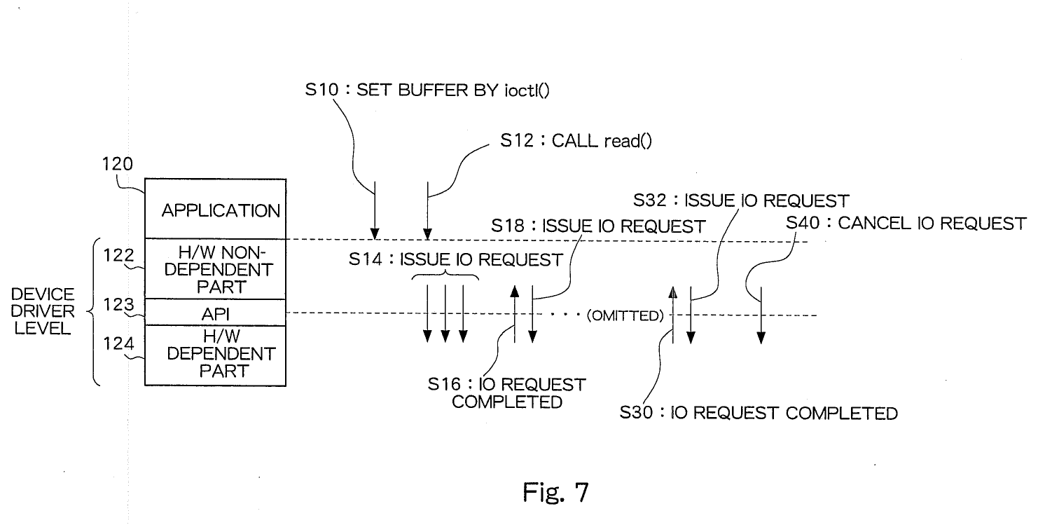

FIG. 6 shows an example in which the kernel area 58 has three buffers 190, 192, and 194. Note that the number of buffers in the kernel area 58 and their sizes can be changed dynamically. This dynamic change can be made by a program that changes the buffer specifications during program execution (this program is executed typically by the CPU 54, which functions as a setting unit or a change unit). That is, this program is designed to allow the buffer specifications to be changed without recompiling. The following describes, with reference to FIGS. 7-11, an example of how the buffer specifications are changed.

FIG. 7 is a diagram showing the association between the internal processing flow in the target device and the software/hardware structure shown in FIG. 2. Referring to this figure, an API (Application Program Interface) 123 is added as software that connects the H/W non-dependent part 122 and the H/W dependent part 124 shown in FIG. 2.

The H/W non-dependent part 122 manages general system call routines such as ioctl( ) and read( ) that, when called by the application 120, cause the H/W dependent part 124 to perform the corresponding processing via the API 123. ioctl( ) is a routine that supports a function for setting the number of buffers and their sizes provided in the kernel area 58, and read( ) is a routine that reads data.

First, the application 120 sets the values, such as the function value and the attribute values, in the arguments of ioctl( ). That is, the application 120 issues an instruction to change the current number of buffers and the current size to a new number of buffers (for example, three) and a new size (for example, 4 K bytes) (S10) According to this instruction, ioctl( ) generates IO request structures, one for each buffer, and sets the values according to the buffer size.

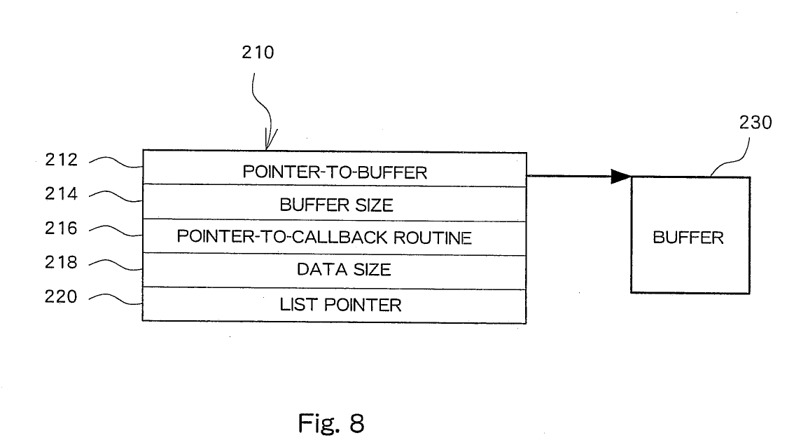

FIG. 8 is a diagram showing an IO request structure 210. The IO request structure 210 is a structure generated for each buffer allocated in the kernel area 58. The IO request structure 210 has the following fields: pointer-to-buffer 212, buffer size 214, pointer-to-callback routine 216, data size 218, and list pointer 220. The pointer-to-buffer 212 indicates the address of a buffer 230 allocated in the kernel area 58, and the buffer size 214 indicates the size of the buffer 230. The pointer-to-callback routine 216 indicates an address that is set for receiving a notification from the H/W dependent part 124 to indicate the completion of an IO request. The data size 218 indicates the size of data actually stored in the buffer. The list pointer 220 is set to control a list of multiple IO request structures 210.

In the H/W non-dependent part 122, ioctl( ) sets the values in the fields of the IO request structure 210. At this time, the list pointer 220 is initialized to NULL, and the data size 218 is initialized to 0. In addition, the request wait queue managed by the H/W dependent part 124 is initialized to NULL based on the instruction from ioctl( ).

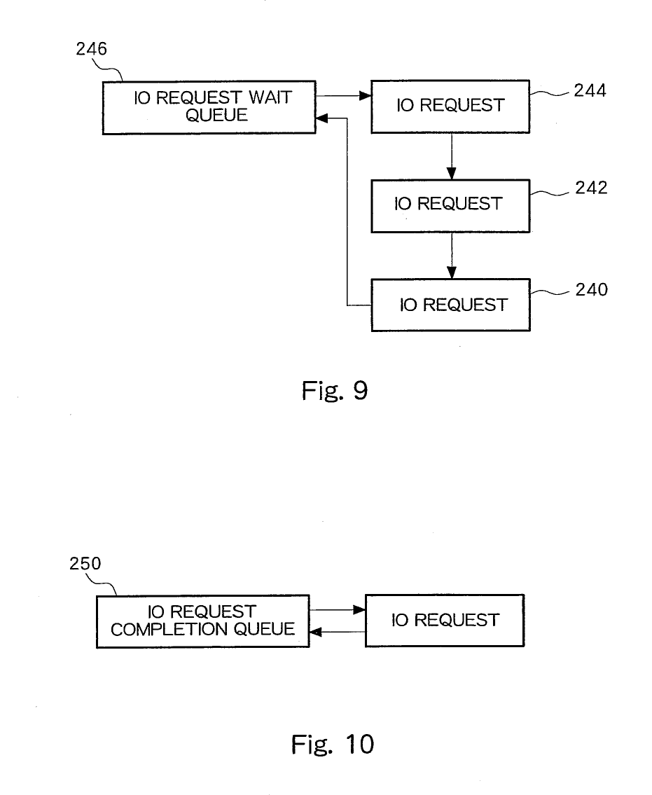

To receive data from the host, the application 120 calls read( ) provided by the H/W non-dependent part 122 as shown in FIG. 7 (S12). In response to this call, the H/W non-dependent part 122 sequentially issues IO requests, one for each buffer, to the H/W dependent part 124 via the API 123 (S14). The H/W dependent part 124 manages the IO request wait queue to sequentially process the issued IO requests, and sequentially connects IO request structures 210, corresponding to the issued IO requests, to the IO request wait queue. FIG. 9 is a diagram showing this processing in which three issued IO requests 240, 242, and 244 are connected to an IO request wait queue 246.

The DMA 74 transfers the data packet, stored in the FIFO 180 or FIFO 182 in the buffer memory 68, to the buffer corresponding to the first IO request in the IO request wait queue 246 (buffer reserved by the IO request structure 210 corresponding to this IO request). When the transfer to the buffer is completed, the IO request structure 210 is connected to the end of a completion queue 250. And, in accordance with the pointer-to-callback routine 216 that is set in the IO request structure 210, the callback routine of the H/W non-dependent part 122 is called (S16, S30).

Next, the callback routine that is called checks the IO request completion queue 250 shown in FIG. 10. The callback routine removes the first IO request from the IO request completion queue 250 and confirms whether the value that is set in the data size 218 of the corresponding IO request structure 210 is 0. If the result indicates that the setting value is 0; that is, the packet size is 0 byte long, the callback routine cancels the IO request, because there is no more received data packet, thereby removing the unnecessary IO request structures 210 connected to the IO request wait queue 246 (S40).

In contrast, if the result indicates that the value is not 0, the callback routine copies the data packet, whose size is set in the data size 218 of the IO request structure 210, from the buffer, pointed to by the pointer-to-buffer 212 of the IO request structure 210, to the buffer 200 in the user area 60. The callback routine checks if the value in the data size 218 is equal to the buffer size. If the value is not equal to the buffer size, the callback routine cancels the IO request, because there is no more data packet from the host, thereby removing the unnecessary IO request structures 210 connected to the IO request wait queue 246. On the other hand, if the value is equal to the buffer size, the callback routine re-issues an IO request using the used IO request structure 210, because there is another data packet from the host (S18, S32) and, before the wait state is entered again, checks the IO completion queue 250. The same processing is repeated thereafter.

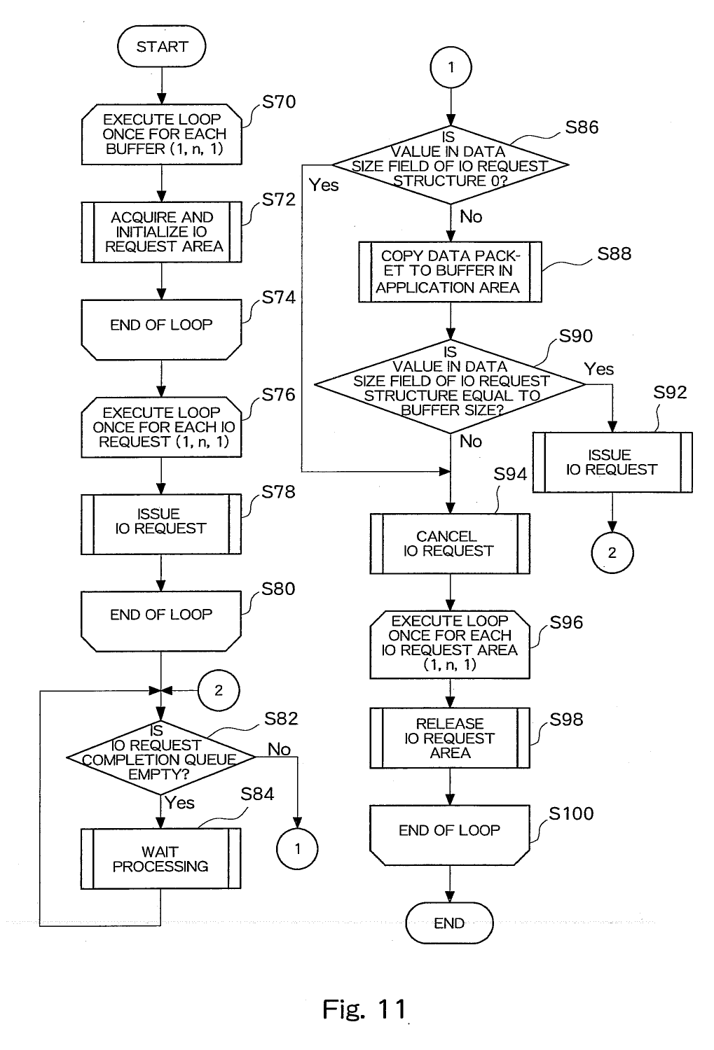

FIG. 11 is a flowchart showing the flow of processing of an IO request. In the description below, n buffers are reserved in the kernel area 58. First, when the application 120 uses ioctl( ) to specify the number of buffers (n) and the buffer size, ioctl( ) acquires n IO request areas and initializes them (S70, S72, S74). Next, n IO requests are issued from the H/W non-dependent part 122 to the H/W dependent part 124 (S76, S78, 580). A check is made as to whether the IO request completion queue is empty and, if it is empty, wait processing is performed to wait for receipt of the next data packet (S84).

On the other hand, if the IO request completion queue is not empty, the first IO request is removed from the queue and a check is made as to whether the value of the data size field of the corresponding IO request structure is 0 (S86). If the value is not 0, the data packet is copied to the buffer in the user area (S88) and, in addition, a check is made as to whether the value of the data size field of the IO request structure is equal to the buffer size (S90). If the checking shows that they are equal, the next IO request is issued (S92) and the processing in step S82 and the subsequent steps are repeated. In contrast, if they are not equal or if the value of the data size field is 0 in step S86, the IO request cancellation processing is performed, as a result of judging that the data transfer is terminated (S94). After that, the IO request areas reserved by n IO request structures are released (S96, S98, S100).

Although the method has been described above in which the number of buffers or the size of buffers in the kernel area 58 are changed in response to an instruction from the application 120 of the target device, it is also possible to use the method in which the number of buffers or the size of buffers are changed in response to an instruction from the H/W non-dependent part 122 of the device driver.

As described above, it is possible to set buffers dynamically in the buffer memory 68 of the USB target controller 66. The problem here is that the number of buffers and the buffer size can be set arbitrarily. To set the number of buffers and the buffer size not arbitrarily but according to some specific criteria, the following describes how to diagnose the communication efficiency and how to determine the number of buffers and the buffer size from the diagnosed communication efficiency before setting them. The number of buffers and the buffer size are elements that determine the buffer storage capability indicating how much data and what size of data can be stored. To determine the number of buffers and the buffer size on the basis of the communication efficiency is to set the number of buffers and the buffer size so that the communication speed and the hardware resource utilization are compatible. In general, increasing the number of buffers and the buffer size makes the data transfer smooth. However, simply increasing the number of buffers and the buffer size involves a waste of the memory 56 or an insufficiency of the memory 56. Therefore, in this exemplary embodiment, the number of buffers and the buffer size are determined and set so that the communication efficiency is increased or optimized. The state of the optimum communication efficiency, which refers to the state in which the communication efficiency is highest, is defined as the state in which the balance between the reduction in the wasteful use of the memory 56 and the communication speed either produces the best evaluation score or belongs to the best category under the specified evaluation criteria.

The communication efficiency may be diagnosed and determined by the CPU 54 or the control unit 72 of the target device or by the CPU 24 or the control unit 42 of the host. Distributed processing is also possible in which the diagnosis is made by the host and the determination is made by the target device. For example, when the diagnosis and determination are made by the CPU 54 of the target device, the diagnosis and determination program stored in the memory 56 is executed by the CPU 54. This configuration allows the CPU 54 to function as the diagnostic unit and the determination unit.

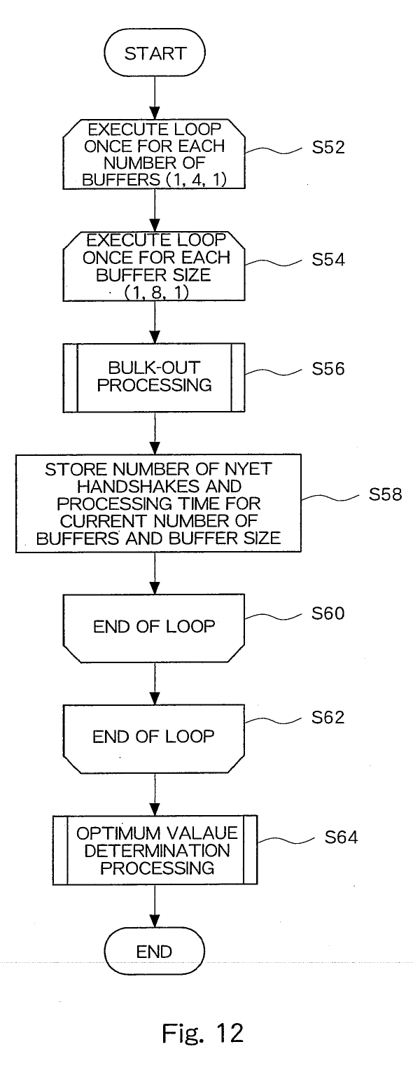

FIG. 12 is a flowchart showing the processing procedure for finding the optimum values for the number of buffers and the buffer size in the kernel area 58. In the example shown in this flowchart, the initial value is set to 1, the maximum value is set to four, and the increment is set to 1 for the external loop in which the number of buffers is changed (S52, S62), and the initial value is set to 1 K bytes, the maximum value is set to 8 K bytes, and the increment is set to 1 K bytes for the internal loop in which the buffer size is changed (S54, S60). After setting those values, the bulk-out transfer processing is performed for each of the number of buffers and each size (S56), and the number of NYET handshakes generated during the processing and the processing time required for the transfer are recorded. This processing is an example of processing performed by the diagnostic unit that diagnoses the data communication efficiency under multiple conditions for the storage capability.

In the optimum value determination processing (S64), the optimum number of buffers and the buffer size are determined on the basis of this result. Although in this example the optimum value is determined from the number of NYET handshakes and the processing time, it is also possible to determine the optimum value from only the number of NYET handshakes or from only the processing time. The optimum value determination processing in this flowchart is an example of determination processing by the determination unit.

As described in FIG. 3 to FIG. 5, the NYET handshake is sent when the FIFOs at the end point in the buffer memory 68 are not free. Once the NYET handshake is sent, the NAK handshake is sent instead of the NYET handshake repeatedly while the condition in which the FIFOs are not free continues. That is, the number of NYET handshakes, which indicates how many times a sequence of conditions in which the FIFOs are not free have occurred, corresponds to the data transfer speed.

The number of NAK handshakes may be used instead of the number of NYET handshakes. In this case, the number of NAK handshakes, which indicates how long a sequence of conditions in which the FIFOs are not free has continued, corresponds to the data transfer speed. However, note that the number of NAK handshakes is usually much larger than the number of NYET handshakes.

The processing time, the number of NYET handshakes, and the number of NAK handshakes may be measured by the target device side or by the host side. When they are measured by the host side, a mechanism must be built such that the result is notified to the target device side to allow the target device side to change the buffer configuration.

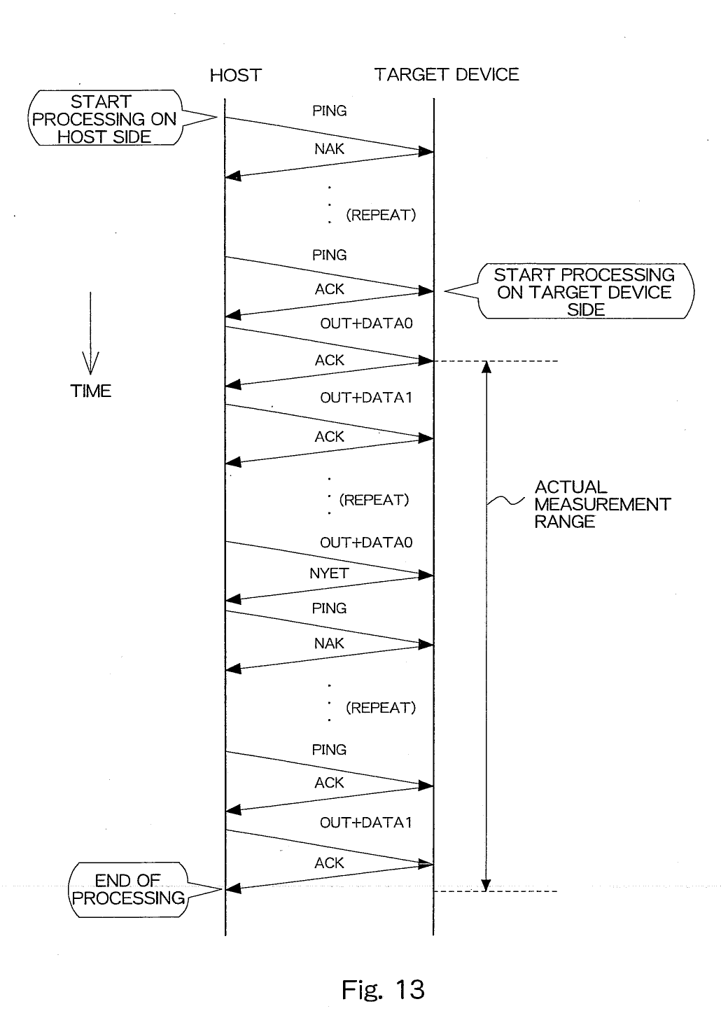

FIG. 13 is a diagram showing the range of processing time measurement and the NAK handshake measurement. In the figure, the packets transferred between the host and the target are shown by the arrows on the time axis extending from the top to the bottom of the figure. In this example, it is assumed that, after the application 110 in the host is started and processing is started on the host side, the application 120 in the target device remains unstarted for a while. So, immediately after the communication is started, the process is repeated in which the PING token packet is sent from the host to the target device and the NAK handshake is returned from the target device to the host. After that, when the application 120 in the target device gets started, the processing on the target device side is started. That is, the process is repeated in which the ACK handshake is returned from the target device to the host and either the OUT token packet and the DATA0 data packet or the OUT token packet and the DATA1 data packet are sent from the host to the target device. As described above, the NYET handshake, the PING token packet, and the NAK handshake are transferred during this process.

In this sequence of communication, the time during which the application 120 in the target device remains unstarted is not related to the data transfer efficiency. To eliminate this stage from the evaluation of the data transfer efficiency, the measurement should be started from the time the OUT token packet is sent first. The measurement is ended, for example, when all data packets are written from the buffer in the kernel area 58 to the user area 60.

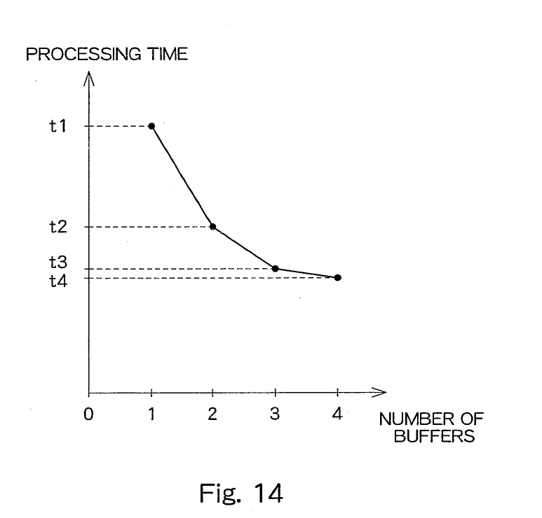

FIG. 14 is a diagram schematically showing the result measured in S58 in FIG. 12. For simplicity, this figure shows the relation between the number of buffers (horizontal axis) and the processing time (vertical axis) under the condition in which the buffer size is set constant. In this example, as the number of buffers is increased (1, 2, 3, and 4), the processing time is decreased (t1, t2, t3, and t4) and the rate of decrease of the processing time is also decreased.

In step S64 in FIG. 12, the optimum number of buffers is determined in consideration of the balance between the decrease in the processing time and the increase in efficiency brought about by increasing the number of buffers. In some cases, although the processing time is shortest when the number of buffers is 4, the optimum number of buffers may be determined to be three, because the decrease rate from t3 to t4 (represented by (t3-t4)/t3), which is smaller than the predetermined threshold (for example, 0.05), is so small that it approaches the limit. The optimum the buffer size can also be determined in the same manner. When considering both the processing time and the number of NYET handshakes, the measurement results of both factors may be weighted for evaluating them comprehensively.

The optimum number of buffers and the optimum buffer size may vary according to the device configuration of the host side and the device configuration of the target device side (number of FIFOs, DMA performance, CPU performance, memory performance, etc. of USB target controller). This means that the optimum number of buffers and the optimum buffer size may also be determined for each device configuration.

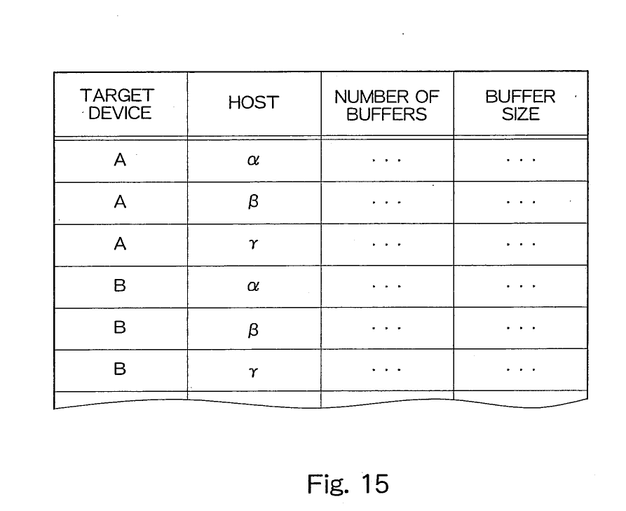

FIG. 15 is a schematic table created by determining the optimum number of buffers and the buffer size for a combination of target devices and host devices. More specifically, the table shows how many buffers and what buffer size should be set when hosts α, β, and γ send data to target devices A and B. Such a table is created, for example, by the manufacturer. The number of buffers and the buffer size, which are based on the table, may be entered by a manager or a service engineer via the UI of the target device, or may be programmed so that they are automatically set by referencing the table stored on the network.

Instead of the method described above, it is also possible to determine the number of buffers and the buffer size best suited for the host or the target device during repeated communications and, based on the result, dynamically change the setting. In this case, if the experimental communication is performed for many parameters as in the example in FIG. 12, the communication is sometimes affected. To avoid this condition, it is possible to measure the communication speed using parameter values close to the initial parameter values and, based on the measurement result, change the number of buffers and the buffer size for higher efficiency. More specifically, a check is made as to whether the communication speed is increased sufficiently to exceed the threshold when the initially-set number of buffers is incremented by one and, based on the checking result, the number of buffers is changed again.

An example of the bulk-out transfer in the USB2.0 HS mode has been described. In transferring data in other modes of USB, the buffers in the kernel area 58 may be optimized in the same manner. This exemplary embodiment may be applied also to other serial communications and parallel communications that are wired or wireless.

In the above description, a data packet received by, and temporarily stored in, the USB target controller 66 is transferred to the kernel area and then to the user area. Such a two-stage transfer mode is usually used in an OS; for example, Linux, that has the kernel mode and the user mode. That is, when data are transferred in the user mode, a data packet stored in the kernel area (managed in the kernel mode) is copied to the user mode area specified by the application.

In the above description, it is assumed that data transferred in two stages are stored somewhat longer in a storage area such as a buffer in the user area. However, data transferred in two stages may be processed without being stored in the storage area. For example, image data are converted and displayed in real time.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A data communication system comprising:
a receiving unit that receives communication data, one data element at a time;
a first storage unit that temporarily stores the received data element;
a first transfer unit that transfers the data element stored in the first storage unit;
a second storage unit that temporarily stores the data element transferred by the first transfer unit;
a second transfer unit that transfers the data element stored in the second storage unit;
a third storage unit that acquires the data elements transferred by the second transfer unit and stores the data;
a change unit that changes data element storage capability of the second storage unit; and
a diagnostic unit that diagnoses communication efficiency of the data on the basis of the storage capability changed by the change unit, wherein
the receiving unit controls reception of a next data element on the basis of the data element storage-ability status of the first storage unit, and
the first transfer unit controls transfer of data elements from the first storage unit to the second storage unit on the basis of the data element storage-ability status of the second storage unit.

2. The data communication system according to claim 1, further comprising:
a determination unit that determines storage capability to be set for the second storage unit on the basis of the diagnosis result of the diagnostic unit, wherein
the change unit changes the data element storage capability of the second storage unit again on the basis of the determination result of the determination unit.

3. The data communication system according to claim 1, further comprising a data rewritable storage area, wherein
the second storage unit is built by providing one or more small areas, each storing one data element, in the storage area, and
the change unit changes a number of the small areas or a size of the small area to change the storage capability.

4. The data communication system according to claim 3, wherein
the diagnostic unit diagnoses the communication efficiency on the basis of the size of the storage area used by the second storage unit.

5. The data communication system according to claim 1, wherein
the diagnostic unit diagnoses the communication efficiency on the basis of required time measured during communication of the data.

6. The data communication system according to claim 1, wherein
the receiving unit comprises an adjustment unit that adjusts a time to receive each data element on the basis of a dialog carried out with a sending side, and
the diagnostic unit diagnoses the communication efficiency on the basis of an analysis of the dialog.

7. The data communication system according to claim 1, further comprising a sending device that sends the data, one data element at a time, wherein
the diagnostic unit is provided in the sending device.

8. The data communication system according to claim 5, further comprising a sending device that sends the data, one data element at a time, wherein
the diagnostic unit is provided in the sending device.

9. The data communication system according to claim 6, further comprising a sending device that sends the data, one data element at a time, wherein
the diagnostic unit is provided in the sending device.

10. A computer-readable medium storing a program causing a computer to execute a process for data communication, the process comprising:
receiving communication data, one data element at a time;
temporarily storing the received data element in a first storage unit;
transferring the data element stored in the first storage unit;
temporarily storing the data element, transferred from the first storage unit, in a second storage unit;
transferring the data element stored in the second storage unit;
acquiring the data elements transferred from the second transfer unit and storing the data in a third storage unit;
changing data element storage capability of the second storage unit; and
diagnosing communication efficiency of the data on the basis of the changed storage capability, wherein
when the communication data are received, one data element at a time, reception of a next data element is controlled on the basis of the data element storage-ability status of the first storage unit, and
when the data element stored in the first transfer unit is transferred, the transfer of the data element is controlled on the basis of the data element storage-ability status of the second storage unit.

11. The recording medium according to claim 10, further comprising:
determining storage capability to be set for the second storage unit on the basis of the diagnosis result of the diagnostic unit; and
changing the data element storage capability of the second storage unit again on the basis of the determination result.

12. A data communication method, the method comprising:
receiving communication data, one data element at a time;
temporarily storing the received data element in a first storage unit;
transferring the data element stored in the first storage unit;
temporarily storing the data element, transferred from the first transfer unit, in a second storage unit;
transferring the data element stored in the second storage unit;
acquiring the data elements transferred from the second transfer unit and storing the data in a third storage unit;
changing data element storage capability of the second storage unit; and
diagnosing communication efficiency of the data on the basis of the changed storage capability, wherein
when the communication data are received, one data element at a time, reception of a next data element is controlled on the basis of the data element storage-ability status of the first storage unit, and
when the data element stored in the first storage unit is transferred, the transfer of the data element is controlled on the basis of the data element storage-ability status of the second storage unit.

13. The method according to claim 12, further comprising:
determining storage capability to be set for the second storage unit on the basis of the diagnosis result of the diagnostic unit; and
changing the data element storage capability of the second storage unit again on the basis of the determination result.

14. A data receiving device comprising:
a receiving unit that receives communication data, one data element at a time;
a first storage unit that temporarily stores the received data element;
a first transfer unit that transfers the data element stored in the first storage unit;
a second storage unit that reserves a data element storage area in a data rewritable storage area and temporarily stores the data element transferred by the first transfer unit;
a second transfer unit that transfers the data element stored in the second storage unit;
a third storage unit that acquires the data elements transferred by the second transfer unit and stores the data; and
a setting unit that sets data element storage capability of the second storage unit, wherein
the receiving unit controls reception of a next data element on the basis of the data element storage-ability status of the first storage unit,
the first transfer unit controls transfer of data from the first storage unit on the basis of the data element storage-ability status of the second storage unit, and
the second storage unit changes specifications of the area reserved in the storage area on the basis of the setting by the setting unit.

15. The data receiving device according to claim 14, wherein
the setting by the setting unit can be executed each time the data are received.

16. A computer-readable medium storing a program causing a computer to execute a process for data communication, the process comprising:
receiving communication data, one data element at a time;
temporarily storing the received data element in a first storage unit;
transferring the data element stored in the first storage unit;
reserving a data element storage area in a data rewritable storage area and setting a second storage unit;
temporarily storing the data element, transferred from the first storage unit, in the second storage unit;
transferring the data element stored in the second storage unit;
acquiring the data elements transferred from the second storage unit and storing the data in a third storage unit; and
setting data element storage capability of the second storage unit, wherein
when the communication data are received, one data element at a time, reception of a next data element is controlled on the basis of the data element storage-ability status of the first storage unit,
when the data element stored in the first storage unit is transferred, transfer of data from the first storage unit is controlled on the basis of the data element storage-ability status of the second storage unit, and
when the second storage unit is set, specifications of the area reserved in the storage area are changed on the basis of the setting of the data element storage capability of the second storage unit.

17. The computer-readable medium according to claim 16, wherein
the setting of the data element storage capability of the second storage unit can be executed each time the data are received.
